(19) United States
(12) Patent Application Publication
(10) Pub. No.: US 2010/0048334 A1
(43) Pub. Date: Feb. 25, 2010

(54) HYDRAULIC TENSIONING UNIT FOR FLEXIBLE DRIVES

(75) Inventors: Roman Kern, Forchheim (DE); Reinhard Koch, Wachenroth (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/516,078

(22) PCT Filed: Nov. 7, 2007
(86) PCT No.: PCT/EP2007/061969

§ 371 Date: May 22, 2009

(30) Foreign Application Priority Data
Nov. 24, 2006 (DE) 10 2006 055467.1

(51) Int. Cl. F16H 7/08

(52) U.S. Cl. 474/110

(57) ABSTRACT

A hydraulic tensioner intended for use in chain drives of internal combustion engines. The hydraulic tensioner has a pot-shaped housing in which a piston is elastically suspended against a traction element and guided for longitudinal displacement. A damping device forms a leak gap which serves to damp adjusting movements of the piston. The leak gap is defined by a bushing which is inserted into the housing and, at the same time, guides the piston. During an adjusting movement of the piston towards a pressure chamber filled with a hydraulic fluid, a fractional quantity of the hydraulic fluid is displaced via the leak gap. An adjusting movement of the piston in the opposite direction causes a re-flow of the hydraulic fluid via a one-way valve arranged in the housing.

### FIELD OF THE INVENTION

The present invention concerns a hydraulic tensioner for use in traction drives, particularly in chain drives of internal combustion engines. The tensioner comprises a pot-shaped housing forming a cylinder in which a piston is guided for longitudinal movement. In the installed state, the piston is elastically suspended for longitudinal movement against a traction element, and adjusting movements of the piston are damped by a damping device. For this purpose, depending on the adjusting movement of the piston, a fractional quantity of a hydraulic fluid, particularly lubricating oil from the internal combustion engine, can flow out of the pressure chamber through a leak gap or, on reversal of the adjusting movement, flow back into the pressure chamber through a one-way valve.

A hydraulic tensioner of the pre-cited type is known, for instance, from the document DE 40 35 823 C1. This hydraulic tensioner particularly intended for chain drives in internal combustion engines comprises a piston that is guided for longitudinal movement in the cylinder and is indirectly connected to the traction element, i.e. the chain. The piston and the cylinder together define a pressure chamber for receiving the hydraulic fluid. Movements of the tensioner and, thus also, adjusting movements of the piston toward the chain enlarge the pressure chamber, so that a partial vacuum is formed enabling a re-flow of hydraulic fluid into the pressure chamber through a one-way or non-return valve. An opposite movement of the piston in the direction of the cylinder diminishes the pressure chamber which causes a fractional quantity of the hydraulic fluid to be displaced out of the pressure chamber through a leak gap. The configuration of the leak gap has a substantial influence on the damping characteristic of the hydraulic tensioner. If the tensioner is configured for a large leakage, the tensioner becomes softer, i.e. vibrations and impacts of the traction element resulting from large adjusting movements of the piston are substantially damped. A small leak gap permitting only a weak flow of fluid limits the damping action to small adjusting movements of the piston which disadvantageously lead to an introduction of higher forces into the traction drive.

The damping behavior of a hydraulic tensioner is generally optimally tuned to a particular point of operation. A soft damping is suitable for reducing noise development in the chain drive in a lower engine speed range. At higher speeds of rotation, the internal combustion engine manifests a different operational behavior through which, with a soft damping, a larger quantity of hydraulic fluid is displaced out of the pressure chamber through the leak gap. In this case, a situation can occur in which the time for re-suction of hydraulic fluid into the pressure chamber is insufficient, so that malfunctions of the hydraulic tensioner can occur.

### OBJECTS OF THE INVENTION

It is an object of the present invention to provide a configuration for a hydraulic tensioner of the pre-cited type such that the tensioner can be economically manufactured and possesses a high degree of functionality.

This and other objects and advantages of the invention will become obvious from the following detailed description.

### SUMMARY OF THE INVENTION

The invention achieves the above objects by the fact that the housing and the piston are made without chip removal by a deep drawing method. The deep drawing method used by the invention makes finishing work superfluous, so that these components can be made at low cost in large series. After assembly, i.e. when the piston has been inserted into the housing, a separate securing element forms an end stop for the piston. The position and the shape tolerances of all the components of the tensioner of the invention are designed such that a defined leak gap determining the damping characteristic of the damping device is formed between the piston and the housing or between the piston and the securing element.

Further advantageous features of the invention will be discussed in the following.

According to one advantageous feature of the invention, an effective securing element is constituted by a separate bushing that is fixed in the housing after the piston has been mounted. The bushing is designed with regard to its wall thickness and length such that a functionally required, defined leak gap is formed that, at the same time, also defines the guiding lash between the piston and the bushing.

The bushing provided as a securing means is inserted into the housing, so that its front end forms an end stop for the piston which comprises a radial step.

Preferably, the bushing is positioned in the housing through a press or interference fit. Alternatively, joining by a fusion of material is also feasible, for instance, by soldering or gluing the bushing to the housing for obtaining its permanent positional fixing.

An alternative to a bushing as a securing element, the invention also includes a locking ring fixed by positive engagement on the piston and cooperating with a radially stepped portion of the housing. The design of the locking ring and an associated annular groove for this ring in the piston is such that the piston with inserted locking ring can be pushed into the housing or cylinder. After passing the leak gap between the piston and the housing, the locking ring expands automatically and forms an anti-disintegration feature between the housing and the piston.

A suitable locking ring is, for example, a radially pre-tensioned circlip. Alternatively, a closed steel ring or a plastic ring with adequate elasticity and wear resistance may likewise be used as a locking ring. In the case of plastic rings, the choice is limited to plastics having the required wear resistance and fatigue strength. Preferably, the locking rings used have a circular cross-sectional profile, but locking rings having a square or rectangular cross-sectional profile and cooperating with annular grooves of appropriate configuration in the piston may also be used.

The one-way or non-return valve of the hydraulic tensioner of the invention is a disk valve likewise made without chip removal. For this purpose, a disk-shaped, elastic, sluing valve plate may be used. This valve plate positioned, for example, in the region of the housing bottom can be directly associated to a supply bore through which the hydraulic fluid can re-flow into the pressure chamber. Through the proposed configuration of the valve plate that is centered in the housing, for example, through centering lugs and loaded by a force of the compression spring of the hydraulic tensioner, the assembly of the one-way valve is simplified and, moreover, this one-way valve is integrated in the tensioner without need of additional design space.

In another suitable embodiment, the disk valve is a valve comprising two parts made without chip removal, one part being a valve body in the form of a disk that is guided and secured against loss in a housing configured as a retaining element. This structure enables a short reaction time for opening and closing the valve already at the slightest differences in pressure or upon a reversal of flow of the hydraulic fluid, which has an advantageous effect on the mode of operation of the hydraulic tensioner.

### BRIEF DESCRIPTION OF THE DRAWINGS

For a better understanding of the invention, examples of embodiment are described more closely below with reference to the appended drawings.

FIG. 1 shows a semi-section of a hydraulic tensioner in which a securing element of the piston is a positionally fixed locking ring cooperating with a radial step of a housing;

FIG. 2 shows a variant of a hydraulic tension in which the securing element is a bushing inserted into the housing and cooperating with an annular portion of the piston;

FIG. 3 is a sectional view along line 3-3 of FIG. 2 that clarifies the structure of a one-way valve;

FIG. 4 is a sectional view of a disk valve along line 4-4 of FIG. 5,

FIG. 5 is a top view of the disk valve of FIG. 4.

### DETAILED DESCRIPTION OF EXAMPLES OF EMBODIMENT

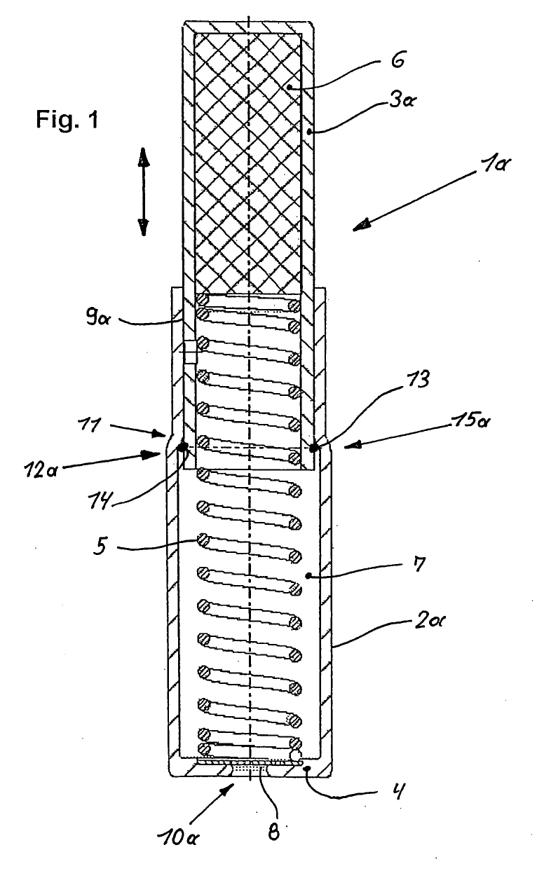

FIG. 1 is a simplified representation of a hydraulic tensioner 1a used in traction drives, particularly in chain drives, for achieving an adequate pre-tensioning of the traction element. The tension 1a comprises a pot-shaped housing 2a, that may also be designated as a cylinder, and is made without chip removal, in particular by deep drawing. A likewise pot-shaped piston 3a made without chip removal by deep drawing is guided for longitudinal displacement in the housing 2a. A compression spring 5 inserted between a bottom 4 and the piston 3a effects a displacement of the piston by force-loading towards a traction element not shown in FIG. 1. A spring end of the compression spring 5 associated to the piston 3a is supported on a volume reducer 6 of the piston 3a. The housing 2a and the piston 3a together define a pressure chamber 7 filled with hydraulic fluid. A preferred hydraulic fluid is lubricating oil from the internal combustion engine that can flow into the pressure chamber 7 through a supply bore 8 arranged in the bottom 4. When a force in introduced by the traction element into the piston 3a for displacing the piston 3a towards the pressure chamber 7, a fractional quantity of the hydraulic fluid is displaced through a leak gap 9a formed as an annular gap between the housing 2a and the piston 3a. The hydraulic fluid then flows into a reservoir, not shown in FIG. 1, which surrounds the housing 2a at least partially. An adjusting movement of the piston 3a in the opposite direction causes a pressure differential between the pressure chamber 7 and the reservoir, so that, after an opening resistance has been overcome, a one-way valve 10a communicating with the supply bore 8 opens. A movement triggered by the compression spring 5 and displacing the piston 3a towards the traction element initiates a re-suction effect for a short-term filling of the pressure chamber 7. For this, a one-way valve 10a opening with the smallest possible delay is required.

For realizing an anti-disintegration feature between the housing 2a and the piston 3a, the housing 2a comprises a radially stepped end portion 11 on which the piston 3a is guided. The deep drawing method used for making the housing 2a and the piston 3a assures quality of production without additional finishing. At the same time, the production method also assures the defined guiding lash required between the housing 2a and the piston 3a, which guiding lash, in turn, defines the leak gap 9a and the damping characteristic of the tensioner 1a. For realizing an effective anti-disintegration feature of the inter-inserted components, a securing element 12a in the form of a locking ring 13 is positioned in an end region of the piston 3a to cooperate with an end stop 15a of the radial step 11 of the housing 2a. The locking ring 13 is preferably a radially pre-tensioned circlip inserted into an annular groove 14 of the piston 3a. The annular groove 14 is configured such that, during insertion of the piston 3a into the radial step 11 of the housing 2a, the locking ring 13 yields sufficiently in radial direction to enable an unobstructed assembly. When the locking ring 13 has passed the radial step 11, the pre-tensioned locking ring 13 is displaced radially outwards producing an overlap between the locking ring 13 and the radial step 11 which together form an end stop 15a.

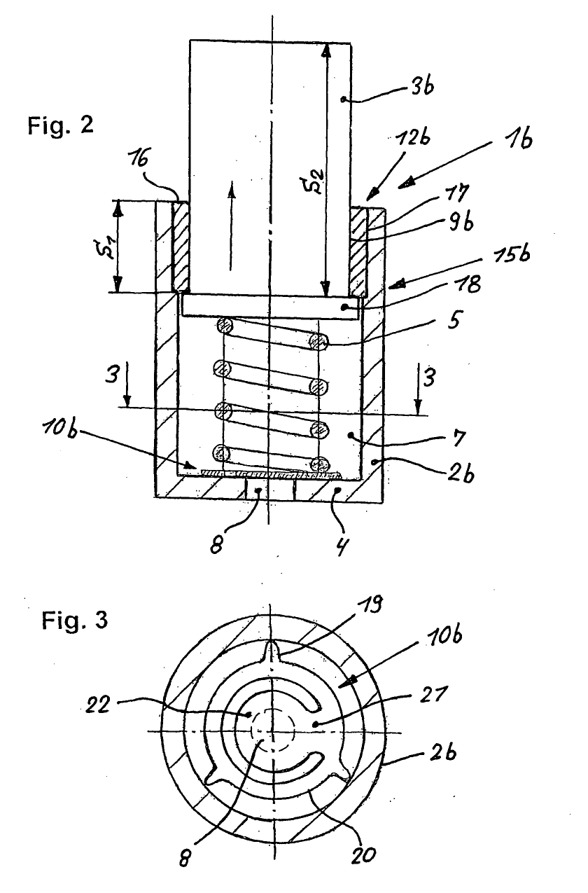

The hydraulic tensioner 1b of FIG. 2 comprises a housing 2b and a piston 3b between which is inserted a compression spring 5. Differently from the tensioner 1a of FIG. 1, in this embodiment, the securing element 12b is formed by a bushing 16. The bushing 16 is inserted into an end region of the housing 2b after the piston 3b has been mounted. As an alternative to the reception 17 for the bushing 16 illustrated in FIG. 2, the bushing 16 can also be inserted directly into the cylindrical reception of the housing 2b. Through an exact dimensional adjusting of the components housing 2b, piston 3b and bushing 16 to one another, a defined leak gap 9b forming a damping device is formed in the installed condition of said components.

For achieving an exact guidance of the piston 3b, the bushing 16 has a length (S₁) of =0.4 of the length “S₂” of the piston 3b. An optimal leak gap is an annular gap having a dimension of =0.08 mm and arranged between the outer peripheral surface of the piston 3b and the inner contour of the bushing 16.

An efficient anti-disintegration feature between the housing 2b and the piston 3b is assured through the end stop 15b in that an end annular portion 18 of the piston 3b cooperates with a front end of the bushing 16. The one-way valve 10b is arranged in the region of the housing bottom 4 and force-loaded directly by a spring end of the compression spring 5 so as to bear against the bottom 4 and cooperate with the supply bore 8 for the hydraulic fluid.

The structure of the one-way valve 10b can best be seen in FIG. 3. This one-way valve designed as a sheet metal disk can likewise be made without chip removal and comprises an outer ring 20 which, for assuring a defined installation position, comprises peripherally arranged centering lugs 19. The outer ring 20 is connected through a tongue 21 to an elastically sluing valve plate 22 that opens and closes the supply bore 8 in the installed condition.

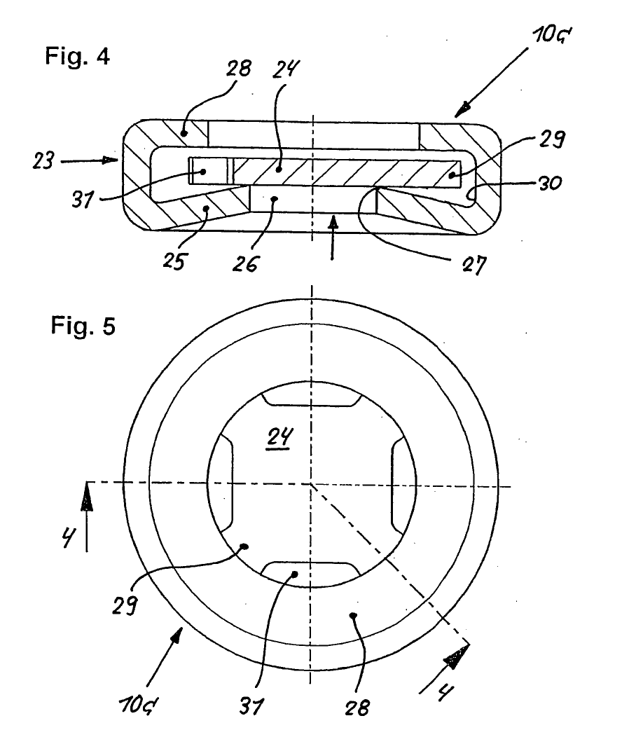

FIGS. 4 and 5 show an alternative embodiment of a one-way valve 10c which comprises two parts made without chip removal. A retaining element 23, also to be designated as housing, is provided for guiding a disk-shaped valve body 24 which is thus secure against loss. A bottom 25 of the retaining element 23 has a conical shape and forms a central opening 26. This opening 26 has an edge zone configured as a valve seat 27 which, in the installed state, is in contact with the valve body 24. When hydraulic fluid flows towards the one-way valve 10c in direction of the arrow, the valve body 24 is displaced till it comes to bear against a rim 28 which, as shown in FIG. 5, is continuous in peripheral direction. The rim 28 is bent inwards at a right angle after the valve body 24 has been inserted into the retaining element 23, so that a stop for the valve body 24 and, at the same time, an efficient anti-loss feature of the valve body 24 can be realized in the pre-assembled state of the one-way valve 10c. Advantageously, the one-way valve 10c is positioned in a housing by an interference fit without need of further contrivances. A guiding and centering of the valve body 24 is effected through peripherally spaced apart extensions 29 which are associated with lash to an inner wall 30 of the retaining element 23. FIG. 5 further clearly shows the flow cross-sections formed in the open state of the one-way valve 10c. The total flow cross-section corresponds to the sum of all the recesses 31 of the valve body 24 that are formed between the peripherally spaced apart extensions 29.

### LIST OF REFERENCE NUMERALS

1a Tensioner
1b Tensioner
2a Housing
2b Housing
3a Piston
3b Piston
4 Bottom
5 Compression spring
6 Volume reducer
7 Pressure chamber
8 Supply bore
9a Leak gap
9b Leak gap
10a One-way valve
10b One-way valve
10c One-way valve
11 End portion
12a Securing element
12b Securing element
13 Locking ring
14 Annular groove
15a End stop
15b End stop
16 Bushing
17 Reception
18 Annular portion
19 Centering lug
20 Outer ring
21 Tongue
22 Valve plate
23 Retaining element
24 Valve body
25 Bottom
26 Opening
27 Valve seat
28 Rim
29 Extension
30 Inner wall
31 Recess

1. A hydraulic tensioner used in traction drives, particularly chain drives of internal combustion engines, comprising;
a pot-shaped housing forming a cylinder in which a piston is guided for longitudinal displacement and elastically suspended against a traction element;
a damping device which is configured as a leak gap and damps adjusting movements of the piston;
a hydraulic fluid, particularly a lubricating oil of the internal combustion engine, being able to flow out of a pressure chamber through the leak gap and flow back into the pressure chamber through a one-way valve, wherein
the housing and the piston are manufactured by a deep drawing method and, in an inserted state of the piston in the housing, a securing element forms an end stop for the piston, while the leak gap is formed between the piston and the housing or between the piston and the securing element.

2. A tensioner according to claim 1, wherein, after mounting the piston, a bushing, which is positionally fixed in the housing, forms the securing element, and a guiding lash of the piston defines the leak gap between the piston and the bushing.

3. A tensioner according to claim 2, wherein a radial step of the piston is configured as an annular portion and forms an end stop for the piston, said the end stop cooperating with a front end of the bushing.

4. A tensioner according to claim 2, wherein the bushing is positioned in the housing by an interference fit.

5. A tensioner according to claim 2, wherein the bushing is fixed by a connection formed by fusion of materials.

6. A tensioner according to claim 1, wherein the securing element is a locking ring that is fixed by positive engagement on the piston and cooperates with a radially stepped end portion of the housing.

7. A tensioner according to claim 6, wherein the locking ring is a pre-tensioned circlip and is inserted into an annular groove of the piston.

8. A tensioner according to claim 6, wherein the locking ring is a closed steel or plastic ring.

9. A tensioner according to claim 1, wherein the one-way valve is a disk valve that is made without chip removal and arranged within the housing.

10. A tensioner according to claim 9, wherein the one-way valve comprises an elastically arranged valve plate that cooperates with a supply bore of the housing.

11. A tensioner according to claim 9, wherein the one-way valve is a two-piece disk valve comprising a retaining element that is configured as a housing and forms a valve seat and a valve body configured as a disk is guided, secure against loss, in said retaining element.
